(19) United States
(12) Patent Application Publication
(10) Pub. No.: US 2011/0277635 A1
(43) Pub. Date: Nov. 17, 2011

(54) METHOD FOR DISCHARGING THE DUST THAT OCCURS DURING OPERATION OF A DEDUSTING SYSTEM FOR RAW GAS

(75) Inventor: Stefan Hamel, Wenden (DE)

(73) Assignee: UHDE GmbH, Dortmund (DE)

(21) Appl. No.: 13/138,252

(22) PCT Filed: Jan. 19, 2010
(86) PCT No.: PCT/EP2010/000276

§ 371 Date: Jul. 25, 2011

(30) Foreign Application Priority Data
Jan. 30, 2009 (DE) 10 2009 006 878.3

(51) Int. Cl. B01D 46/00

(52) U.S. Cl. 95/279

(57) ABSTRACT

A method for discharging the dust that occurs from pressurized gasification, using a dust precipitator having at least one discharge container assigned to it, is supposed to be configured in such a manner that nitrogen introduction into the raw gas is minimized or completely avoided, in order to free subsequent chemical syntheses from introduction of nitrogen, if at all possible, right from the start. This is achieved in that filter elements are positioned in the dust precipitator, which elements are back-flushed by means of a gas that contains carbon dioxide or pure CO₂ gas.

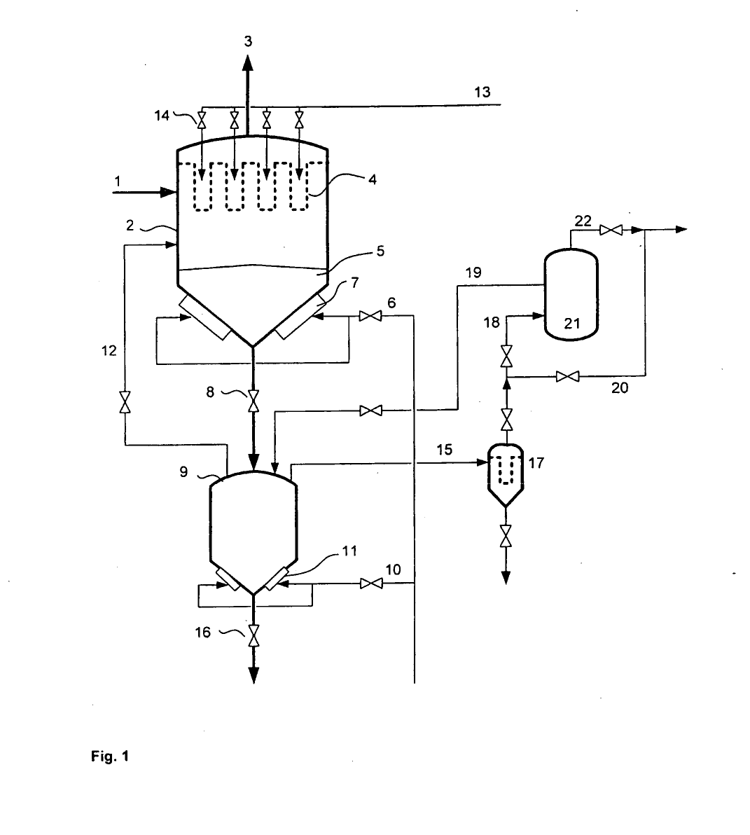

The invention is directed at a method for discharging the dust that occurs during operation of a dedusting system for raw gas, of the type indicated in the preamble of claim 1.

Thermal gasification of solid fuel, such as, for example, different types of coal, peat, hydrogenation residues, recycling material, wastes, biomasses, and flue ash, or a mixture of the aforementioned substances, is carried out under elevated pressure and high temperature, with the goal of producing a raw gas having a high energy content and/or having a composition that is advantageous for further chemical syntheses. The raw gas is charged with flue dust, which has its origin in the ash content of the fuel fed in. The flue dust is present in the form of particles that must be precipitated and removed from the pressurized space before further use. In the case of dry precipitation, for example in a cyclone or in a filter, the solid, which is generally very fine-grained, occurs as a bulk material before it is discharged from the pressurized space. Naturally, there is gas, here raw gas, that is found in the gap volume of the bulk particle material, which is discharged with the solid and must be removed before any further use or disposal of the ash.

After precipitation of the flue ash from the raw gas, the ash is first collected over a certain period of time, before this batch is discharged. In this connection, the batch is usually transferred from the intermediate storage container into a discharge container, which is still at the same high pressure level at this time. The discharge container is subsequently uncoupled and relaxed to a lower pressure level. The ash contained in the discharge container is transported away for further treatment, disposal and/or storage. After the flue ash has been emptied out, the empty discharge container is brought back up to system pressure by feeding gas in, and coupled with the intermediate storage container, in order to take up the next collected batch of flue ash.

Possible design embodiments of such filter apparatuses and the placement of the filter elements within it for dust precipitation from the raw gas of a pressurized gasification system are described, for example, in DE 40 08 742, DE 35 15 365, or U.S. Pat. No. 7,182,799.

For continuous filtering of the raw gas stream, it is necessary to clean the filter elements from time to time, by means of brief back-flushing, and thus to relieve them of the filter cake that has built up on the raw gas side. For this purpose, the cleaning gas must be available at a pressure level above the filter pressure, so that a short-term gas stream with a required pulse can be achieved.

Usually, in gasification systems, pressurization of the discharge container and also cleaning of the filter elements are carried out with nitrogen, which is available, to a sufficient extent, from the air separation system. The use of nitrogen has been tested and has matured to a very great extent. If the goal of the gasification system is the production of a synthesis gas for subsequently carrying out chemical syntheses, then the nitrogen component in the synthesis gas is extremely undesirable, and furthermore is generally restricted to limit values that are dependent on the synthesis, in each instance.

The task of the present invention consists in configuring a method for discharging the dust that occurs, in such a manner that nitrogen introduction into the raw gas is minimized or completely avoided, in order to free subsequent chemical syntheses from introduction of nitrogen, if at all possible, right from the start.

This task is accomplished, according to the invention, with a method of the type indicated initially, in that filter elements are positioned in the dust precipitator, which elements are back-flushed by means of a gas that contains carbon dioxide or pure CO₂ gas.

As is evident, with the method of operation according to the invention, the result is achieved that when the dust precipitator is cleaned or when the filter elements are flushed, no additional nitrogen is introduced into the system, but instead, the CO₂ that occurs in any case is used for this method of procedure.

The proportion of inert gases (such as N₂, Ar, for example) and hydrocarbon (such as CH₄, CₓH_{y}, for example) in the gas that contains carbon dioxide should be a total of <50%. The rest consists of CO₂ and can also contain synthesis gas components (CO, H₂), etc., if necessary.

Fundamentally, it is known to use CO₂ as an inertization and conveying medium in the introduction system in the case of pressurized coal dust gasification, as described in DE 10 2007 020 333 A1.

Practical embodiments of the invention are evident from the dependent claims, whereby it is provided, according to the invention, that the back-flushing gas that contains CO₂ is preheated, in order to compensate for the temperature reductions of the carbon dioxide that necessarily occur during relaxation processes such as regulation, container pressurization, feed of carbon dioxide at a low pressure, and the like, in order to thereby allow safe operation.

In this connection, according to the invention, the carbon dioxide for back-flushing is raised to a temperature level such that the required temperature is maintained at the filter elements.

In a further embodiment, the invention provides that the back-flushing gas that contains CO₂ is used for fluidization and loosening of the bulk flue ash in the dust precipitator. Such fluidization or loosening can be practical since the average particle diameters are very slight, for example <2 μm. The use of gas that contains CO₂ or pure CO₂ as a loosening gas has the advantage that only these gas components get into the raw gas.

Since, according to the invention, the back-flushing gas that contains CO₂ is also used to pressurize the discharge container, this component gets into the raw gas while the ash gets into the discharge container, and drives out the part of the gas present in the discharge container, which then flows back into the raw gas.

Aside from avoiding introduction of nitrogen into the raw gas, another advantage of the invention lies in that lesser volume streams are necessary for cleaning the filter elements as compared with nitrogen, since smaller amounts of carbon dioxide are necessary for exerting specific pulses for cleaning the filter elements, because of the greater density of the carbon dioxide, so that the need for compressor outputs is also lowered, because of the smaller amounts.

It is practical if feed lines that are heated from the outside are used to heat the gas that contains CO₂.

Another embodiment of the invention consists in that the gas removed from the discharge container is passed to a dedusting device.

Such dedusted gas from the discharge container can be passed to an intermediate buffer, according to the invention, and can then be used, in part, as a gas for carrying out the method steps described above, as the invention also provides.

Additional characteristics, details, and advantages of the invention are evident from the following description and using the drawing and the cited example.

In the single FIGURE, a system schematic is represented in simplified manner, whereby raw gas is passed to the filter or dust precipitator 2 according to arrow 1. The dedusted raw gas leaves the dust precipitator 2 according to arrow 3, after having passed through the filter elements, which are designated in general with 4.

In the collection space 5 of the dust precipitator 2, the dust that adheres to the filters and is flushed free from them collects in a discharge region that is equipped with fluidization devices 7 in order to loosen the dust for further transport, for which purpose CO₂ or gas that contains CO₂ is fed in to these fluidization devices according to line 6. The dust is then passed into a discharge container 9 by way of the connection line 8; the container, in turn, is equipped with fluidization devices 11 in the exit region, which devices are operated by means of CO₂ or gas that contains CO₂, line 10.

The gas from the gas dome of the discharge container 9 is passed back into the gas space of the dust precipitator 2 by means of the equalization line 12.

A gas feed line 13 for CO₂ or gas that contains CO₂ is provided for cleaning off the filter elements 4, which act on the filter elements in surge-like or pulse-like manner, by way of the back-flush lines 14.

Aside from the equalization line 12, another line 15 out of the gas dome of the discharge container 9 is provided, which line acts on a filter element 17. From here, a buffer container 21 can be acted on, by way of the line 18, the gas of which container acts on the equalization container 9 by way of a recycling line 19, if necessary, or is passed on into the surroundings by way of a line 20, as relaxed gas, according to the line 22, or passed on for further use.

Pressurizing or partly pressurizing the discharge container 9 can also advantageously take place by means of the filter 17 (not shown). For this purpose, the valve to the line 18 (as is generally the case when pressurizing) is closed. Back-flushing gas, which is used to supply 6 and 10, for example, is used for cleaning off the filter 17, whereby the gas then gets through the line 15 for pressurizing the discharge container.

The discharge line for the dust is designated as 16, by way of which the dust can be disposed of after pressure equalization.

The method of operation of the system will be explained below, using a filtering precipitator. However, all types of precipitators that require cyclical or occasional cleaning with a gas are covered by this invention:

The raw gas that contains the flue ash and is under pressure is passed into the filter 2. In this connection, a dedusted synthesis gas 3 and flue ash are obtained, whereby the latter is temporarily stored in the collection space 5. The collection space 5 is characterized by a conical shape that opens into the connection line 8 to the discharge container 9. Fluidization or loosening devices 7 according to the state of the art are provided in the conical region of the collection space, in order to allow discharge of the ash into the discharge container. The fluidization or loosening devices 7 are operated with gaseous carbon dioxide 6. The collection space 5 can be geometrically integrated into the lower container part of the filter housing or consist of a separate container constantly connected with the filter. In the latter case, the lower part of the filter housing is also provided with fluidization and loosening devices, in order to support transport of the flue ash into the collection space. In the former case, in which collection space and filter housing form a geometrical unit, it is generally sufficient to provide fluidization and loosening devices in or in the vicinity of the conical region.

If the flue ash is to be transferred from the collection space 5 into the discharge container 9, loosening gas is added and the connection line 8 is opened. For this purpose, the discharge container is at the same pressure level as filter 2 and collection space 5. In order for the gas displaced by the ash being transported into the discharge container to escape, it is advantageous to provide an equalization line 12 with the filter 2 or the collection space. The equalization line 12 can also be guided to a different destination, such as, for example, a different container, a different filter, etc., in order to carry off the displaced gas.

Fundamentally, however, it has proven to be advantageous to pass the displaced gas back into the container that sends the solid.

The volume that becomes free in the sending container due to the solid running out must be replaced with gas in order to maintain pressure. In the use of carbon dioxide, according to the invention, as a loosening gas and as a filling gas of the discharge container, recirculation of the gas displaced in the discharge container 9 is advantageous, because raw gas components are necessarily contained in the gap volume of the bulk flue ash in the collection space 5. These components are transported along with the transfer of the flue ash into the discharge container, and mix there, at least in part, with the displaced gas, so that the latter contains components of raw gas, which partly get back into the raw gas space of the filter 2 and of the collection space 5, by way of the equalization line.

As in the case of all filtering dust precipitators, a dust cake builds up on the filter elements during the course of cleaning of the raw gas. If this filter cake reaches a predetermined thickness, defined by way of the pressure loss, which increases in accordance with the filter cake layer thickness, cleaning of the filter elements 4 by means of back-flushing is carried out. In this connection, the filter elements 4 can be acted on by a back-flushing gas 13, 14, individually or in groups. This gas flows through the filter elements 4 opposite the filtering direction, and ensures loosening of the filter cake with a corresponding pulse.

Once the transfer of the flue ash into the discharge container has taken place, equalization line 12 and connection line 8 are closed, and uncoupled from the filter and the collection space. The filled discharge container 9 is relaxed to a lower pressure level, which is sufficient to be able to carry out the further method steps; the relaxation gas is carried away 15. Part of the relaxed gas 15 is temporarily stored in a buffer container 21, by way of a filter 17. The rest of the relaxation gas 20 is carried away.

Use of at least one buffer container 21 is particularly advantageous, because in this way, part of the gas 18 relaxed out of the discharge 9 can be used again for partial pressurization 19 of the discharge after emptying. In this way, the amount of gas to be carried away, consisting of gas that contains carbon dioxide and of raw gas components, is reduced.

Another advantage of the buffer container is equalization of the relaxation gas amounts. In the case of the traditional method of procedure of container relaxation, the highest mass stream occurs at the beginning and becomes smaller with a decreasing container pressure. Since small amounts of raw gas components are necessarily contained in the gas to be relaxed, as has been described, the relaxation gas must be passed to suitable use or disposal. In practice, this type of gas is generally passed to incineration. By means of the buffer container, it is possible to gradually equalize the amount of gas carried away, which allows optimized operation of the incineration device.

The flue ash is transferred 16 from the discharge container 9 for further handling. For this purpose, there are fluidization and loosening devices 11 in the run-out region of the discharge container 9 as well as in the collection space 5, in order to facilitate transfer of the flue ash. Loosening and fluidization take place with carbon dioxide 10. After the discharge container has been emptied, it must be brought back to the pressure level of the filter 2 and of the collection space 5, in order to be able to accommodate the next batch of flue ash stored in the collection space 5. Using the gas 19 stored in the buffer container 21, the discharge container is partially pressurized. Pressurizing the discharge container to the required operating pressure takes place by means of further addition of carbon dioxide 10, for example by way of the fluidization and loosening devices 11 of the discharge container 9, or by way of additional feed devices, such as, for example, the one that is provided for feed of the stored gas 19.

The further method steps to which the flue ash is subjected can be, for example, return into the gasification process or treatment for storage or disposal. In the latter case, care must be taken to ensure that the raw gas components that are still necessarily contained in the gap volume of the bulk flue ash are removed. For this purpose, methods are described in U.S. Pat. No. 4,838,898 A and in US 2007/0084117 A1, for example, which free the flue ash precipitated out of a synthesis gas from the remaining raw gas components in multiple method steps.

### EXAMPLE

Isenthalpic relaxation of carbon dioxide, as it occurs, for example, in valves, reduction elements, or perforated disks, results in a clear temperature reduction in the case of carbon dioxide.

For example, carbon dioxide is relaxed from state 1 at p1=50 bar and T1=150° C. to state 2 at p2=2 bar, resulting in a temperature of T2=126.7° C. When using nitrogen, the temperature T2(N2) would be =146.4° C., with the change in state otherwise being the same. In order to guarantee a temperature of 150° C. here, the carbon dioxide must be preheated to approximately 170° C. at p1=50 bar. If one were to use a temperature T1=80° C., a temperature T2=40.7° C. would occur, with the relaxation otherwise being the same, and this temperature would be T2(N2)=73.6° C. in the case of nitrogen.

The above example was selected from the range of typical operating parameters as they occur when pressurizing the discharge container.

The examples illustrate that when carbon dioxide is used, in comparison with nitrogen, the temperature of the carbon dioxide used must be adjusted by means of preheating, in order to compensate the cooling effect during throttling. This is necessary in order to be able to maintain the required process temperatures and not to exceed the permissible temperature gradient, for example by way of the filter elements and the loosening devices.

According to the invention, the carbon dioxide or gas that contains carbon dioxide that is used for cleaning off the filter elements is preheated to such an extent that it has a temperature, after relaxation to operating pressure (of the filter) that lies above the border to the two-phase range. At the same time, the carbon dioxide or the gas that contains carbon dioxide should advantageously have a temperature, after relaxation, that lies above the condensation temperature of the raw gas components.

The same requirements apply in the sector of the fluidization and loosening elements, for the operation of which the carbon dioxide or the gas that contains carbon dioxide that is used must be relaxed. Likewise, preheating of the carbon dioxide or of the gas that contains carbon dioxide must take place to such an extent that its temperature lies above the border to the two-phase range for and during pressurization of the discharge container.

### REFERENCE SYMBOL LIST

1 raw gas
2 filter, dust precipitator
3 dedusted raw gas
4 filter elements
5 collection space
6 introduction line for CO₂ or gas that contains CO₂
7 fluidization device
8 connection line
9 discharge container
10 introduction line for CO₂ or gas that contains CO₂
11 fluidization device
12 equalization line
13 gas feed line
14 back-flushing lines
15 relaxation gas line
16 discharge line
17 relaxation gas filter
18 relaxed gas
19 recycled gas
20 relaxed gas
21 buffer container
22 relaxed gas

1. Method for discharging the dust that occurs during operation of a dedusting system for raw gas, from pressurized gasification, using a dust precipitator having at least one discharge container assigned to it, wherein
filter elements (4) are positioned in the dust precipitator (2), which elements are back-flushed by means of a gas that deviates from air and contains carbon dioxide or by means of pure CO₂ gas, whereby the dust precipitator (2) and the discharge container (9) are connected with one another, in terms of effect, by way of an equalization line (12), for gas return when the discharge container is filled.

2. Method according to claim 1, wherein
the back-flushing gas that contains CO₂ is preheated.

3. Method according to alai claim 1, wherein
the back-flushing gas that contains CO₂ is used for fluidization and loosening of the bulk flue ash in the dust precipitator.

4. Method according to claim 1, wherein
the back-flushing gas that contains CO₂ is used for pressurizing the discharge container.

5. Method according to claim 4, wherein
the back-flushing gas that contains CO₂ is used to loosen the dust in the discharge container.

6. Method according to claim 4, wherein
the gas that contains CO₂ is passed to its location of use through feed lines heated from the outside.

7. Method according to claim 1, wherein
the gas removed from the discharge container is passed to a dedusting device.

8. Method according to claim 1, wherein
the dedusted gas removed from the discharge container is passed to an intermediate storage container and used, at least in part, as gas for carrying out one of the prior method steps.
